(19) United States
(12) Patent Application Publication
(10) Pub. No.: US 2002/0124429 A1
(43) Pub. Date: Sep. 12, 2002

(54) Apparatus for ventilating a pocket of a dryer section of a paper machine

(76) Inventors: G. Randall Straley, Pensacola, FL (US); John F. Ballard, Daphne, AL (US); William M. Allen, Pace, FL (US)

Correspondence Address: STAAS & HALSEY LLP, 700 11TH STREET, NW, SUITE 500, WASHINGTON, DC, 20001, US

(21) Appl. No.: 09/798,915

(22) Filed: Mar. 6, 2001

(51) Int. Cl. F26B 11/02

(52) U.S. Cl. 34/119; 34/117

(57) ABSTRACT

In the dryer section of a paper machine, the paper web is pressed against the dryer cylinders by means of an air-permeable endless dryer fabric. A ventilator apparatus extends transversely across the paper machine located outside the pocket above and below the fabric turning rolls. Air from the ventilator is forced into the pocket through the fabric in the nips formed by the fabric and the fabric turning roll. This air dilutes the moisture driven from the sheet by the dryer can. The ventilator apparatus also creates a negative pressure region to exhaust air from the pocket. This exhaust air is used to scour the boundary layer of moisture laden air from the incoming fabric. The two-pass ventilator apparatus has two individual chambers separated by an induction chamber. The primary chamber contains multiple air jet nozzles. The blowing directions of the two longitudinal nozzles may be at different angles with respect to the running direction of the dryer fabric. After feeding the primary chamber, remaining air passes into the secondary chamber. The secondary chamber contains a high velocity inductor nozzle. The inductor nozzle creates the negative pressure region in the interior of the ventilator nearest to the exit side of the pocket. This negative pressure region draws air through the fabric thereby assisting in pocket ventilation.

### BACKGROUND OF THE INVENTION

1. Field of the Invention

The present invention relates generally to multiple tier paper machines and more particularly to the dryer sections of such paper machines. More specifically, the present invention relates to an apparatus for use with such dryer sections for enhancing the removal of moisture and thereby enhancing the drying of the paper being dried in the dryer section.

2. Background of the Invention

In a conventional, double-felted, two-tier dryer section, the sheet is transferred from one dryer to the next dryer through unsupported spans called “open draws”. A significant portion of the moisture in the sheet evaporates from the web as it passes through such “open draws”. The sheet, the dryer surfaces and the dryer fabrics form a series of enclosed dryer pockets, the ends of which are open to the dryer section, machine room or enclosed hood. The water vapor, which leaves the sheet in these “open draws”, tends to accumulate within the enclosed pockets. The high humidity then diffuses along each pocket toward the open ends of the pocket. The highest pocket humidity remains near the center of the pocket and the lowest pocket humidity occurs near the lateral edges of the pocket. The resultant high pocket humidity tends to reduce the drying rate and cause non-uniformity in the drying rate in the cross machine direction.

The resultant high pocket humidity is not the only factor reducing the drying rate. It has been found that dryer fabrics because of their rough surface texture exert a frictional resistance to air and, consequently, take along a very thick boundary layer of moisture laden air in their running direction. While in contact with the dryer surface, the evaporated water vapor must be transported by diffusion through this boundary layer. The boundary layer of air creates an additional resistance to the drying process thereby reducing the drying rate.

In general, dryer fabrics have a natural tendency to ventilate the dryer pocket as described by Johansson U.S. Pat. No. 3,384,973. When a fabric starts running off a dryer cylinder, a vacuum is produced in the gap between the fabric and the paper web, which is still in contact with the cylinder surface. This vacuum draws the air through the fabric from outside the pocket. When thereafter the fabric runs onto the guide roll, in a corresponding manner an overpressure is produced in the inlet nip between the dryer fabric and the guide roll. This overpressure forces air from outside of the pocket through the fabric into the dryer pocket. When the fabric runs off of the guide roll, the process is reversed. The air is now drawn through the fabric and out of the pocket. This effect is increased when the fabric runs onto the next drying cylinder creating an overpressure, which presses air out of the pocket.

In order to ventilate the pocket (dilute and purge the humid air from the dryer pocket), ventilating ducts of the type shown in U.S. Pat. No. 3,384,973 and U.S. Pat. No. 5,074,278 are utilized. Since the dryer fabrics have a natural tendency to draw air from outside of the dryer pocket, such ducts are located outside the pocket next to the pocket fabric guide rolls. The ducts then blow dry air through the fabric and into the dryer pockets.

Typically, the amount of air pumped into the pocket by the pocket ventilator along with the natural action of the dryer fabric exceeds the amount of air pumped out of the pocket by the natural action of the fabric. The excess air within the pocket flows out of the ends of the pockets. The airflow out of the ends of the dryer pockets due to such an imbalance tends to cause the edges of the sheet to flutter in the “open draws”. Reducing the pocket ventilator airflow rate can reduce such edge flutter. However, this would be contrary to the need to ventilate the pocket.

Decreasing the permeability of the dryer fabrics can also reduce the natural airflow imbalance. Such reduction in permeability reduces the amount of air pumped in and out of the pocket as well as the imbalance volume flow rate. However, this would also be contrary to the need for pocket ventilation.

Solutions proposed to ventilate the dryer pocket sometimes use multiple orifice ventilators to blow against the fabric creating a positive pressure zone of air between the first dryer and the fabric transfer roll, causing air to penetrate into the pocket through the air-permeable fabric. Other proposed solutions create the same positive pressure zone and in addition use a second series of orifices to blow air in the same direction of the air leaving the pocket by natural ventilation. This in theory creates a negative pressure zone between the fabric turning roll and the second dryer, and in so doing, extracts moisture-laden air from the pocket through the air-permeable fabric.

Still other proposed solutions add a third series of orifices to blow against the incoming fabric to scour away the boundary layer of air before it can be drawn into the dryer pocket.

Most of the foregoing systems introduce dry air into the pocket. Attempts to extract air from the pocket have met with limited success. Moreover, the foregoing arrangements were single-pass ventilators with a single plenum with multiple orifice locations and relied on pocket geometry between the ventilator, dryer cylinder and dryer felt to form an apex.

In a single-pass ventilator, supply air is only fed from one side of the ventilator. Ventilators of this design result in mal-distribution because this type of distributor does not readily provide for discharge perpendicular to the orifice or slot. The addition of screens or perforated plates located between the inlet chamber and the outlet chamber will increase the overall pressure drop, but does not provide a discharge perpendicular to the orifice or slot. Also, the single plenum multiple orifice chamber will not permit the creation of both medium and high velocity air jets without violating the physics law of parallel circuits.

The apex location is crucial in creating the negative pressure zone by directing high velocity air near the apex away from the dryer pocket. Many applications will not allow the ventilator to be installed in a position such that the apex is in the proper position. Accordingly, the negative pressure zone, if created, will be ineffective.

### SUMMARY OF THE INVENTION

The solutions discussed above do not effectively and/or completely solve the problems noted above. Accordingly, it is a principal object of the present invention to provide a new and improved apparatus for ventilating a paper machine pocket, wherein the paper machine pocket is formed by the draws of the paper web, the dryer shell and the fabric runs and fabric guide turning rolls.

It is another object of the present invention to provide hot dry air into the paper machine pocket, which is formed by the fabric and fabric turning rolls.

It is a further object of the present invention to exhaust air from the pocket, which is formed by the fabric turning rolls.

It is a still further object of the present invention to scour the boundary layer of air from the incoming fabric.

In accordance with the above-stated objects, there is provided a dryer section consisting of an upper tier and lower tier of rotating dryers. The upper tier includes a first dryer with the web extending around the first dryer and a second dryer located downstream relative to the first dryer. A lower tier of rotating dryers include a third dryer which is located between the first dryer and the second upper tier dryers such that the web moves from the first dryer towards and around the third dryer and subsequently to and around the second dryer.

A guide turning roll is located between the first and second upper tier dryers. A dryer fabric runs in contact with the web around the first dryer with the fabric then extending around the guide roll and then around the second dryer. A pocket is formed from the felt and between the web extending between the first and third dryers and between the third and second dryers.

A ventilating apparatus is located above the guide roll between the first and second dryers. The ventilating apparatus contains two chambers. The first (or primary) chamber blows air into the pocket through the dryer fabric extending between the first dryer and the guide turning roll. The primary air augments the natural flow of air into the pocket by the natural attendency of the moving dryer fabric providing the dilution air for the pocket. The second (or secondary) chamber creates a negative pressure region in the interior or induction chamber of the ventilating apparatus nearest to the exit side of the pocket. This negative pressure region draws air through the fabric thereby assisting in pocket ventilation. The discharge air from the inductor chamber creates a discharge nozzle. This discharge nozzle is located such that the air will contact the incoming fabric, thereby scouring away the boundary layer of moisture-laden air carried by the fabric.

### BRIEF DESCRIPTION OF THE DRAWINGS

FIG. 1 is a schematic elevational view of the two tier-double felted dryer section;

FIG. 2 is an enlargement of a portion of FIG. 1 illustrating the ventilating apparatus in relation to the dryer pocket;

FIG. 3 is an enlarged cross sectional view of the ventilating apparatus;

FIG. 4 is perspective view of a typical space plate; and

FIG. 5 is a cross sectional view of the ventilating apparatus.

### DETAILED DESCRIPTION OF THE PREFERRED EMBODIMENT

In the present invention, air from the primary chamber 7 of the present invention is forced into the pocket through the fabric 3. This air absorbs the moisture driven from the sheet by the dryer 2. The primary chamber 7 contains two air jet nozzles 10 and 11. After feeding the primary chamber, remaining air passes into the secondary chamber 8. The secondary chamber 8 contains a high velocity inductor nozzle 12. The inductor nozzle (motive air) creates a negative pressure region 13 in the interior of the ventilator nearest to the exit side of the pocket. This negative pressure region 13 draws moisture laden air (suction air) through the fabric. Discharge air is defined as the combination of the motive air and suction air. The discharge air is channeled into an induction chamber or throat 9. The throat ejection is used to scour the boundary layer of air from the incoming fabric.

The present invention is furnished with a balancing damper 29 to regulate the quantity of air in the primary and secondary chambers. This permits adjustment of the supply air to the pocket and the amount of exhaust air through the felt and out of the pocket.

The dryer section includes an upper tier and lower tier of rotating dryers 2. The upper tier includes a first dryer with the web extending around the first dryer and a second dryer located downstream relative to the first dryer. A lower tier of rotating dryers include a third dryer which is located between the first dryer and second upper tier dryers such that the web moves from the first dryer towards and around the third dryer and subsequently to and around the second dryer.

A guide turning roll 5 is located between the first and second upper tier dryers. A dryer fabric runs 3 in contact with the web around the first dryer with the fabric then extending around the guide roll 5 and then around the second dryer. A pocket 16 is formed from the felt and between the web extending between the first and third dryer and between the third and second dryer.

A ventilating apparatus or ventilator 6 is located above the guide roll between the first and second dryers 2. The ventilator 6 is connected to a source of hot dry pressurized air and extends along the entire width of the dryers. The two-pass ventilator 6 has two individual chambers separated by an induction chamber. The first or primary chamber 7 contains two parallel air jet nozzles 10 and 11. The first nozzle 10 is located at a level where the dryer fabric 3 separates from first drying cylinder but the web is still in contact with the first dryer 2. The second nozzle 11 is located at a level below the first nozzle. In general, the blowing direction of the two longitudinal nozzles 10 and 11 is perpendicular to the running direction of the fabric 3 but may be at different angles with respect to the running direction of the dryer fabric 3.

After feeding the primary chamber 7, remaining air passes into the secondary chamber 8. The secondary chamber 8 contains a high velocity venturi or third nozzle 12. The third nozzle 12 discharges a jet of air at high velocity into the throat of the inductor chamber 9 creating a negative pressure region 13 in the interior of the ventilator nearest to the exit side of the pocket. This negative pressure region 13 draws air through the fabric 3 thereby assisting in pocket ventilation.

The discharge air from the inductor chamber is a combination of supply air from the secondary chamber and exhaust air from the dryer pocket. This fourth discharge nozzle 15 is positioned such that the air will contact the incoming fabric 3 before the point at which the fabric 3 separates from the first drying cylinder, thereby scouring away the boundary layer of moisture laden air carried by the fabric 3.

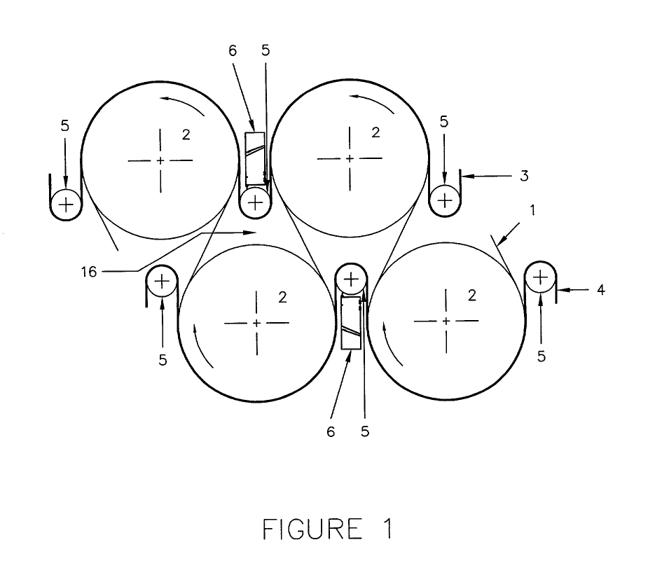

More specifically, in FIG. 1, the paper web 1 runs over the dryers 2 in a serpentine direction from left to right. Two endless individual dryer fabrics 3 and 4 are furnished to press the paper web into intimate contact with the heated drying cylinders 2. The fabrics are highly permeable and woven of synthetic material. Each of the fabrics 3 and 4 operates on one tier of dryers 2 and therefore must be turned over guide rolls 5 between the dryer cylinders 2. Since the dryer fabrics 3 and 4 are endless, they also contain a return section (not shown) which runs above and below the dryers. The return sections are furnished with an arrangement for stretching the fabric in such a manner that the fabric presses the paper web against the dryer surface (not shown). A ventilating apparatus 6 is located above and below the guide turning rolls 5 between dryers 2 of each tier. Each ventilating apparatus 6 extends the full cross machine width of the dryer cylinders. The ventilating apparatuses 6 are supplied with hot-dry pressurized air from a fan system (not shown). The hot dry air is conveyed from the fan to the ventilating apparatuses through a network of ductwork (not shown).

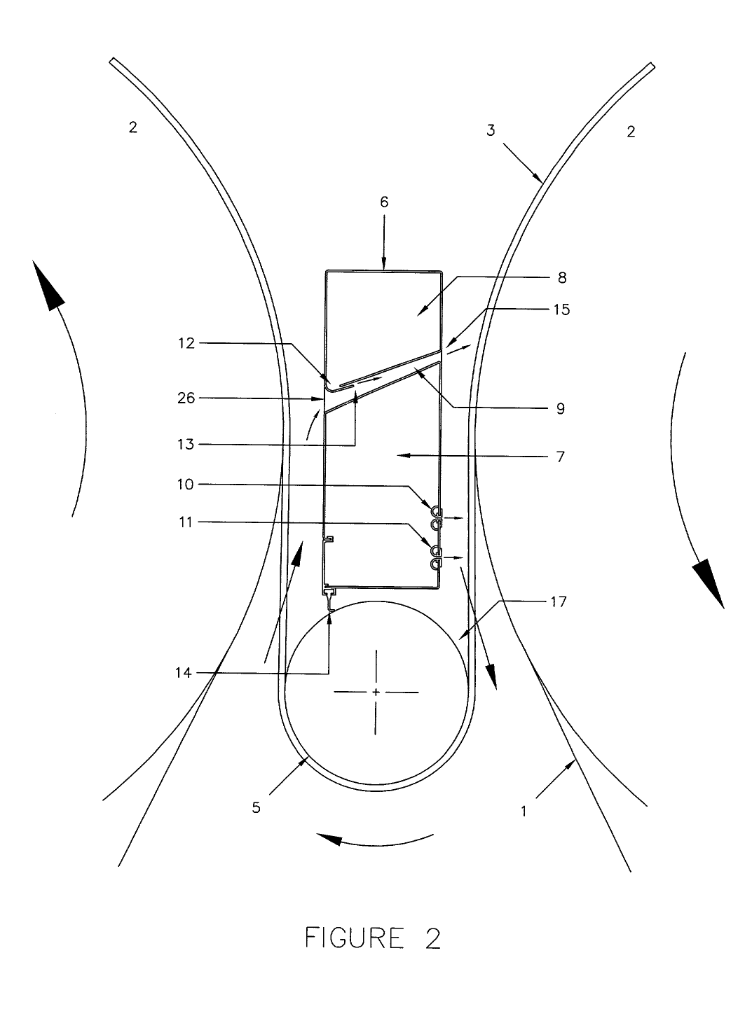

FIG. 2 is an enlarged view of FIG. 1 showing a simplified cross section of the ventilating apparatus 6 in relation to the dryer pocket 16. The two-pass ventilator has two individual chambers 7 and 8 separated by an induction chamber 9. The first or primary chamber 7 contains two parallel air jet nozzles 10 and 11. The first nozzle 10 is located at a level where the dryer fabric separates from the first drying cylinder but the web is still in contact with the first dryer. The second nozzle 11 is located at a level below the first nozzle. In general, the blowing direction of both longitudinal nozzles is perpendicular to the running direction of the fabric but may be at different angles with respect to the running direction of the dryer fabric.

After feeding the primary chamber 7, the remaining air passes into the secondary chamber 8. Secondary chamber 8 contains a high velocity venturi or third nozzle 12. The third nozzle 12 discharges a jet of air at high velocity into the throat of the inductor chamber 9 creating a negative pressure region 13 in the interior of the ventilator nearest to the exit side of the pocket. This negative pressure region 13 draws air through the fabric 3 and into ventilator 6 through suction slot 26 thereby assisting in pocket ventilation. A seal 14 is furnished between the primary chamber 7 and the guide roll 5 to direct the air leaving the pocket toward the negative pressure region 13 and to prevent the air from being re-entering the pocket 16 at nip point 17.

The discharge air from the inductor chamber 9 is a combination of supply air from the secondary chamber 8 and exhaust air from the dryer pocket. This fourth discharge nozzle 15 is located such that the air will contact the incoming fabric 3 before the point at which the fabric 3 separates from the first drying cylinder 2, thereby scouring away the boundary layer of moisture laden air carried by the fabric 3.

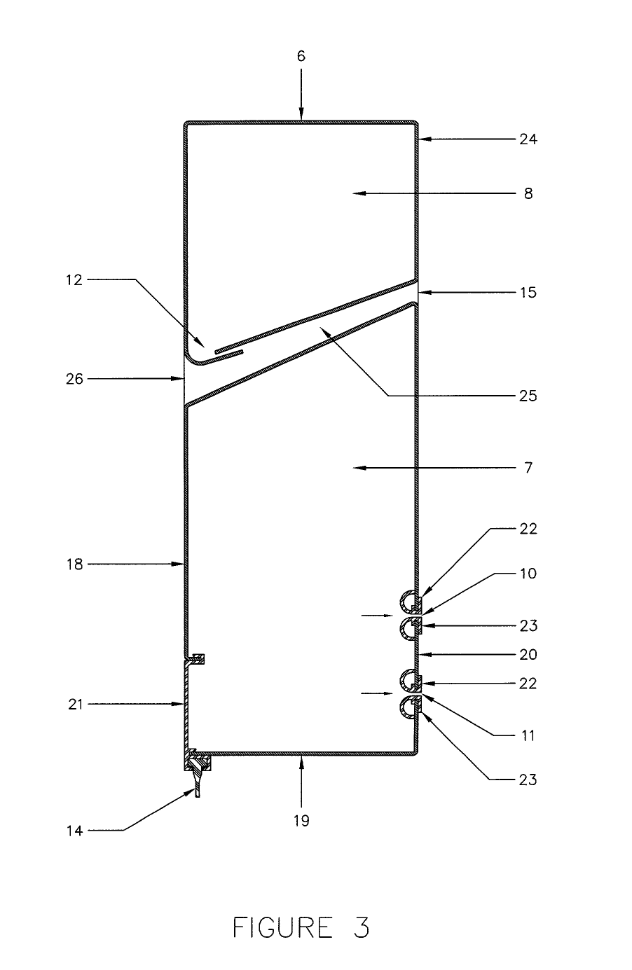

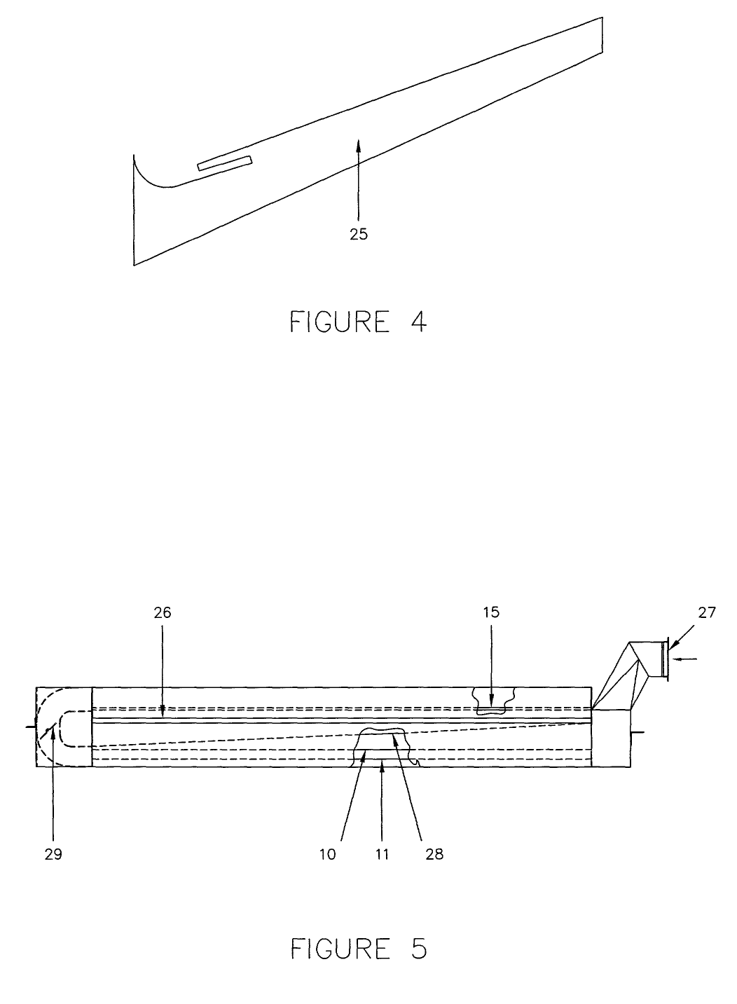

FIG. 3 is a simplified enlarged cross section of ventilating apparatus 6. Primary chamber 7 is defined by formed sheet metal components 18, 19 and 20 along with guide roll seal extrusion 21 and nozzle extrusions 22 and 23. Secondary chamber 8 is formed by sheet metal component 24. Induction chamber 9 is formed by sheet metal components 18 and 24. Spacing for primary chamber 7 and secondary chamber 8 along with inductor nozzle 12 is accomplished by installing spacer plates 25 along the cross machine length of the ventilator. FIG. 4 shows the details of a typical space plate 25 detail. Primary nozzles 10 and 11 are defined by extrusions 22 and 23. Extrusions 22 and 23 are low profile with a radius entrance to smoothly accelerate the airflow into the nozzles 10 and 11 without creating a bluff body interference.

FIG. 5 is a simplified cross machine direction view of the ventilating apparatus 6. Supply air enters primary chamber 7 through duct connection 27. Primary chamber 7 is furnished with a tapered baffle 28 to insure uniform cross machine air distribution. A balancing damper 29 is furnished between primary chamber 7 and secondary chamber 8 to permit adjustment of the supply air to the pocket and the amount of exhaust air through the felt and out of the pocket.

Many modifications and variations of the present invention will be readily apparent to those skilled in the art by a consideration of the detailed description contained hereinafter taken in conjunction with the annexed drawings. However, such modifications and variations fall within the spirit and scope of the present invention as defined by the appended claims.

What is claimed is:

1. A dryer section apparatus for drying a web, comprising:
a dryer section consisting of upper and lower tiers of rotating dryers, the upper tier including a first dryer with the web extending there around and the second dryer located downstream of the first dryer, the lower tier of rotating dryers includes a third dryer located between the first and second upper tier dryers such that the web moves from the first dryer towards and around the third dryer and subsequently to and around the second dryer;
a guide turning roll located between the first and second upper tier dryers, such that the dryer fabric runs in contact with the web around the first dryer with the fabric extending around the guide roll and then around the second dryer, such that a pocket is formed from the felt and between the web which extends between the first and third dryer and between the third and second dryer; and
a ventilating apparatus located above the guide roll containing a first primary chamber which blows air into the pocket through the dryer fabric which extends between the first dryer and the guide turning roll, the primary air augmenting the natural flow of air into the pocket by the tendency of the moving dryer fabric providing dilution air for the pocket and a second secondary chamber which creates a negative pressure region in the interior of the ventilating apparatus nearest the exit side of the pocket, the negative pressure region drawing air through the fabric thereby assisting in pocket ventilation while the discharge air from the inductor chamber creates a discharge nozzle located such that air contacts the incoming fabric, thereby scouring away the boundary layer of moisture-laden air carried by the fabric.

2. A dryer section apparatus as set forth in claim 1, wherein the first and second chambers of the ventilating apparatus are separated by an induction chamber.

3. A dryer section apparatus as set forth in claim 1, wherein the first primary chamber contains two parallel air jet nozzles, one of the nozzles being located at a level where the dryer fabric separates from the first drying cylinder where the web is still in contact with the first dryer and a second nozzle which is located at a level below the first nozzle, such that the direction of blowing of the two longitudinal nozzles is perpendicular to the running direction of the fabric but may be altered to be at different angles with respect to one another or the direction of running of the dryer fabric.

4. A dryer section apparatus as set forth in claim 1, wherein the second chamber is provided with a high velocity third nozzle which discharges a jet of air at high velocity into the inductor chamber creating a negative pressure region in the interior of the ventilator nearest the exit side of the pocket, the negative pressure region drawing air through the fabric thereby assisting in pocket ventilation.

5. A dryer section apparatus as set forth in claim 1, wherein the discharge air from the inductor chamber is a combination of supply air from the secondary chamber and exhaust air from the dryer pocket such that air contacts the incoming fabric before the point at which the fabric separates from the first drying cylinder, thereby scouring away the boundary layer of moisture laden air carried by the fabric.

6. A dryer section apparatus as set forth in claim 1, wherein the primary chamber consists of formed sheet metal components and a guide roll seal extrusion and nozzle extrusions.

7. A dryer section apparatus as set forth in claim 1, including a seal formed between the primary chamber and the guide roll directing air leaving the pocket toward the negative pressure region of the ventilating apparatus to prevent air from re-entering the pocket.

8. A dryer section apparatus as set forth in claim 1, wherein the secondary chamber is formed by sheet metal components.

9. A dryer section apparatus as set forth in claim 1, wherein the induction chamber is formed by sheet metal components of the primary and secondary chambers.

10. A dryer section apparatus as set forth in claim 1, including spacer plates positioned along the cross machine length of the ventilator providing spacing for the primary and secondary chambers along with the inductor nozzle spacing.

11. A dryer section apparatus as set forth in claim 3, wherein the primary nozzles are defined by extrusions of low profile with a radius entrance to smoothly accelerating the airflow into the nozzles without creating interference.

12. A dryer section apparatus as set forth in claim 1, wherein the ventilating apparatus extends along the entire width of the dryers.

13. A dryer section apparatus as set forth in claim 1, wherein the ventilating apparatus is supplied with hot, dry pressurized air from a fan system through a network of ductwork.

14. A dryer section apparatus as set forth in claim 13, including a duct connection permitting supply air to enter the primary chamber.

15. A dryer section apparatus as set forth in claim 1, including a tapered baffle for the primary chamber providing uniform cross machine air distribution from the first and second nozzles.

16. A dryer section apparatus as set forth in claim 1, including a balancing damper between the primary and secondary chambers permitting adjustment of the supply air to the pocket and the amount of exhaust air through the felt and out of the pocket.

17. In the dryer section of a paper machine having rotating dryers, a guide turning roll and a pocket formed between certain of the dryers, the improvement comprising ventilating apparatus in the vicinity of the guide roll and containing a primary chamber through which air is blown into the pocket through the dryer fabric and a second chamber creating a negative pressure region in the interior of the ventilating apparatus nearest the exit side of the pocket.

18. A dryer section as set forth in claim 17, wherein the primary chamber contains two parallel air jet nozzles normally positioned perpendicular to the direction of the fabric and wherein the second chamber is provided with a high velocity nozzle discharging air at high velocity into the inductor chamber creating a negative pressure region nearest the exit side of the pocket.
